(19) United States
(12) Patent Application Publication
(10) Pub. No.: US 2019/0061434 A1
(43) Pub. Date: Feb. 28, 2019

(54) PNEUMATIC TIRE

(71) Applicant: Toyo Tire & Rubber Co., Ltd., Itami-shi (JP)

(72) Inventor: Jiro Taniguchi, Itami-shi (JP)

(73) Assignee: Toyo Tire & Rubber Co., Ltd., Itami-shi (JP)

(21) Appl. No.: 16/053,040

(22) Filed: Aug. 2, 2018

(30) Foreign Application Priority Data
Aug. 28, 2017 (JP) 2017-163593

(51) Int. Cl. B60C 11/12; B60C 11/03

(52) U.S. Cl. CPC B60C 11/1236; B60C 11/032; B60C 2011/1213; B60C 11/1204; B60C 11/0306

(57) ABSTRACT

In a pneumatic tire in which plural land sections 20 are provided in a tread and each of the land sections 20 is provided with plural sipes 30 and at least one recess 32 arranged between the two adjacent sipes 30, in the case where a distance between the sipes 30 on both sides of the recess 32 is set as W1, a distance between the recess 32 and one of the sipes 30 is set as W2, and a distance between the recess 32 and the other sipe 30 is set as W3, each of W2/W1 and W3/W1 is equal to or greater than 0.1 and equal to or less than 0.3.

### CROSS-REFERENCE TO RELATED APPLICATIONS

This application claims the benefit of and priority to Japanese Patent Application No. 2017-163593, filed on Aug. 28, 2017, and the content thereof is incorporated herein by reference in its entirety.

### TECHNICAL FIELD

The present invention relates to a pneumatic tire.

### BACKGROUND ART

As described in PTL 1 to 3, a pneumatic tire in which sipes are formed in a tread has been known. Because an edge effect is exerted by the sipes, such a pneumatic tire provides superior travel performance on a frozen road surface.

In addition, as described in PTL 1 to 3, of the pneumatic tires, in each of which the sipes are formed in the tread, the pneumatic tire which is further formed with recesses has been known. Each of these recesses is provided to take water therein so as to suppress formation of a water film between a ground contact surface of the tread and the road surface. In the case where the water film is unlikely to be formed, the travel performance on the frozen road surface is improved.

PTL 1: JP-A-2009-274726

PTL 2: JP-A-2012-510917

PTL 3: JP-A-2016-107727

### SUMMARY OF THE INVENTION

By the way, it has been desired to further improve the travel performance on the frozen road surface. However, it is not desired to change such a feature that the sipes and the recesses are formed in the tread.

In view of the above, the present invention has a purpose of providing a pneumatic tire, travel performance of which on a frozen road surface is further improved while a structure of a tread formed with sipes and recesses is maintained.

A pneumatic tire of an embodiment is a pneumatic tire in which plural land sections are provided in a tread and each of the land sections is provided with plural sipes and at least one recess arranged between the two adjacent sipes, and is characterized that, in the case where a distance between the sipes on both sides of the recess is set as W1, a distance between the recess and one of the sipes is set as W2, and a distance between the recess and the other sipe is set as W3, each of W2/W1 and W3/W1 is equal to or greater than 0.1 and equal to or less than 0.3.

In the embodiment, because each of W2/W1 and W3/W1 is equal to or greater than 0.1 and equal to or less than 0.3, an edge effect by the sipes and the recess is improved. Thus, travel performance on a frozen road surface is further improved.

### BRIEF DESCRIPTION OF THE DRAWINGS

FIG. 1 illustrates a tread pattern of a pneumatic tire in an embodiment.

FIG. 2 is a view in which a center block 20 is seen in a perpendicular direction to a ground contact surface.

FIG. 3 includes views of modified examples of a sipe shape, in which (a) illustrates a linear sipe 30a that extends in a tire width direction Y, (b) illustrates a single-curve sipe 30b, (c) illustrates a sipe 30c that includes a waved portion and a linear portion, and (d) is a view of a sipe 30d, one end of which is closed in the center block 20, and each of which is seen in the perpendicular direction to the ground contact surface.

FIG. 4 is a cross-sectional view that is taken along line A-A in FIG. 2.

FIG. 5 includes views in which center blocks 20 of pneumatic tires in Comparative Examples and Examples are each seen in the perpendicular direction to the ground contact surface, in which (a) illustrates a center block 20 of a pneumatic tire in Comparative Example 1, (b) illustrates a center block 20 of a pneumatic tire in Example 1, (c) illustrates a center block 20 of a pneumatic tire in Example 2, (d) illustrates a center block 20 of a pneumatic tire in Example 3, and (e) illustrates a center block 20 of a pneumatic tire in Example 4.

### MODE FOR CARRYING OUT THE INVENTION

A pneumatic tire in an embodiment will be described on the basis of the drawings. Note that features of the pneumatic tire in the following description are features in an unloaded state of the pneumatic tire that is attached to a legitimate rim and is filled with air to have a legitimate inner pressure unless otherwise noted. Here, the legitimate rim is specified as the “Standard Rim” in JATMA standards, the “Design Rim” in TRA standards, or the “Measuring Rim” in ETRTO standards. In addition, the legitimate inner pressure is specified as the “Maximum inflation pressure” in the JATMA standards, a maximum value set in the “TIRE LOAD LIMITS AT VARIOUS COLD INFLATION PRESSURES” in the TRA standards, or the “INFLATION PRESSURE” in the ETRTO standards. Note that, in the case of the pneumatic tire for a passenger vehicle, the legitimate inner pressure is 180 kPa.

Note that the legitimate load, which will be described below, is specified as the “Maximum load capacity” in the JATMA standards, the maximum value set in the “TIRE LOAD LIMITS AT VARIOUS COLD INFLATION PRESSURES” in the TRA standards, or the “LOAD CAPACITY” in the ETRTO standards. In the case of the pneumatic tire for the passenger vehicle, the legitimate load is 85% of a corresponding load at the inner pressure of 180 kPa.

The pneumatic tire in the embodiment has a similar structure to a general radial tire except for a structure of a tread. The structure of the pneumatic tire in the embodiment will briefly be exemplified below.

First, a bead is provided on each side in a tire width direction. The bead includes: a bead core that is made of steel wire wound in a circular shape; and a bead filler that is made of rubber and provided on a radially outer side of the bead core. A carcass ply stretches between the beads on both of the sides in the tire width direction. The carcass ply is a sheet-shaped member in which a large number of ply cords arranged in an orthogonal direction to a tire circumferential direction is coated with rubber. The carcass ply defines a framework shape of the pneumatic tire between the beads on both of the sides in the tire width direction and is folded from an inner side to an outer side in the tire width direction around each of the beads so as to wrap each of the beads. A sheet-shaped inner liner that is made of rubber with low air permeability is adhered to an inner side of the carcass ply.

One or plural belts are provided on an outer side of the carcass ply in a tire radial direction, and a belt reinforcement layer is provided on an outer side of the belt in the tire radial direction. The belt is a member that is formed by coating a large number of steel-made cords with rubber. The belt reinforcement layer is a member that is formed by coating a large number of organic fiber cords with rubber. A tread having a ground contact surface is provided on an outer side of the belt reinforcement layer in the tire radial direction. A sidewall is provided on each side of the carcass ply in the tire width direction. In addition to these members, members such as a belt under pad and chafers are provided according to the need for tire functions.

Next, the tread will be described. The tread is formed with a tread pattern that includes plural land sections and plural grooves. Each of the land sections constitutes the single continuous ground contact surface when the legitimate load is exerted on the pneumatic tire, which is attached to the legitimate rim and is filled with the air to have the legitimate inner pressure.

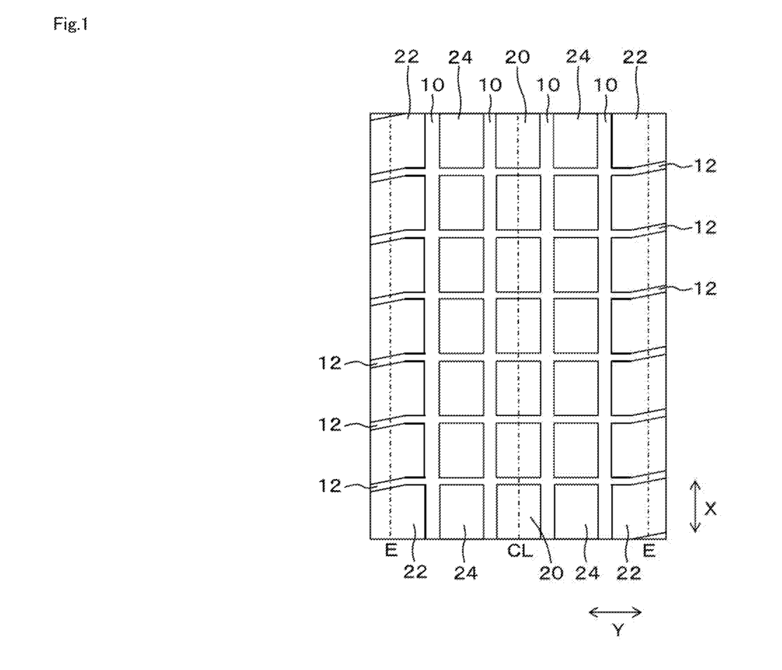

The tread pattern having the land sections is not limited, and an example thereof is a tread pattern as illustrated in FIG. 1. The tread pattern in FIG. 1 is provided with: four main grooves 10, each of which extends in the tire circumferential direction (a direction indicated by an arrow X in the drawing); and a large number of lateral grooves 12, each of which extends in the tire width direction (a direction indicated by an arrow Y in the drawing). In addition, the large number of the land sections that are divided by the main grooves 10 and the lateral grooves 12 are formed.

As the land sections in the embodiment in FIG. 1, plural center blocks 20, each of which is held between the two main grooves 10 near a tire centerline CL, plural shoulder blocks 22, each of which is held between a tire ground contact end E and the main groove 10 near the tire ground contact end E on each of the sides in the tire width direction Y, and plural mediate blocks 24 between the center blocks 20 and the shoulder blocks 22 are formed. The blocks are aligned in the tire circumferential direction X and form block rows.

Note that each of the main grooves does not have to extend linearly in the tire circumferential direction X like the main groove 10 in FIG. 1 but may be bent and extend zigzag in the tire circumferential direction X, may be curved and extend in a waved shape in the tire circumferential direction X, or may extend obliquely with respect to the tire circumferential direction X, for example. In addition, the land sections may be ribs that are divided by the main grooves extending in the tire circumferential direction X but not divided by the lateral grooves and extend in the tire circumferential direction X.

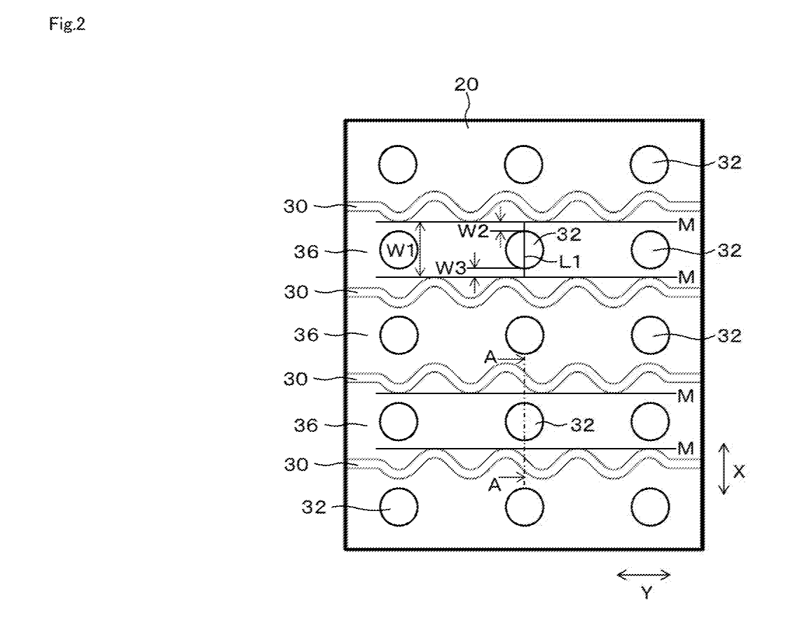

Next, a structure of each of the land sections will be described by using the center block 20 as an example. As illustrated in FIG. 2, sipes 30, each of which extends in the tire width direction Y, are provided in the center block 20. Each of the sipes 30 is a narrow groove, and more specifically, is a groove, an opening of which in the ground contact surface is closed when the pneumatic tire, which is attached to the legitimate rim and is filled with the air to have the legitimate inner pressure, contacts the ground and the legitimate load is exerted thereon. The sipes 30 illustrated in FIG. 2 extend in the tire width direction Y. However, the direction in which the sipes 30 extend is not limited thereto but may be the tire circumferential direction X or an oblique direction to the tire circumferential direction X and the tire width direction Y, for example. In general, each of the sipes 30 has depth in a perpendicular direction to the ground contact surface but may have the depth in a slightly oblique direction to the perpendicular direction to the ground contact surface. The depth of each of the sipes 30 is not limited, but in general, each of the sipes 30 is shallower than the main groove 10. The plural (four in the case illustrated in FIG. 2) sipes 30 are provided in the single center block 20.

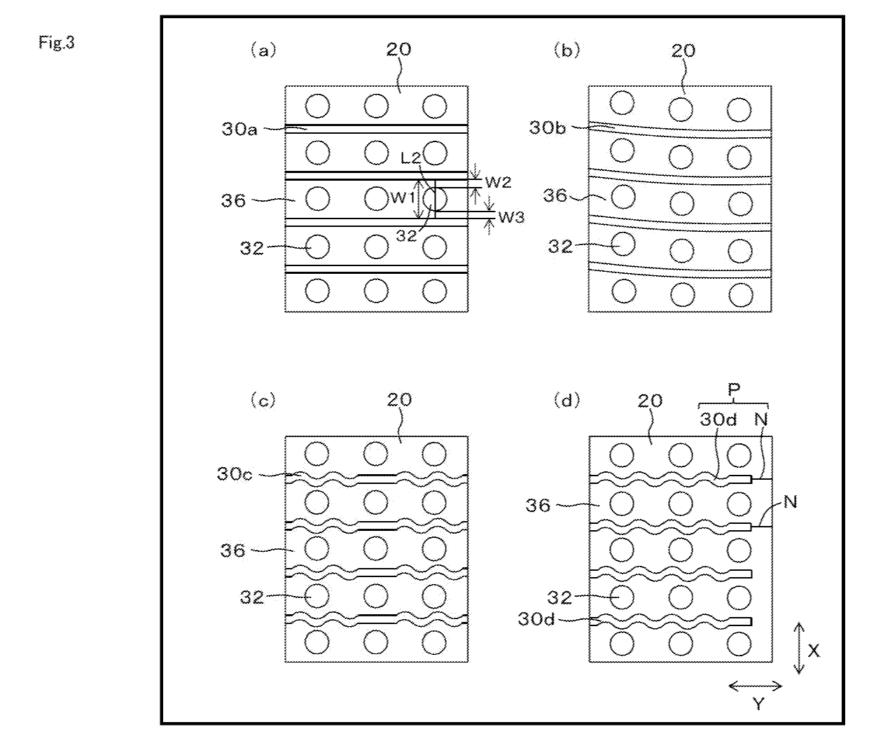

Each of the sipes 30 in FIG. 2 has a waved shape when seen in the perpendicular direction to the ground contact surface. However, the shape of each of the sipes is not limited thereto. Instead of the waved sipes 30, for example, linear sipes 30a illustrated in FIG. 3(a), single-curve sipes 30b illustrated in FIG. 3(b), or sipes 30c, each of which includes waved portions and a linear portion, illustrated in FIG. 3 (c) may be provided.

In addition, both ends of each of the sipes 30 in FIG. 2 reach both ends of the center block 20 in a width direction and are opened to the main grooves 10. However, like the sipes 30d illustrated in FIG. 3 (d), at least one of the ends may be closed in the center block 20 and may not be opened to the main groove 10.

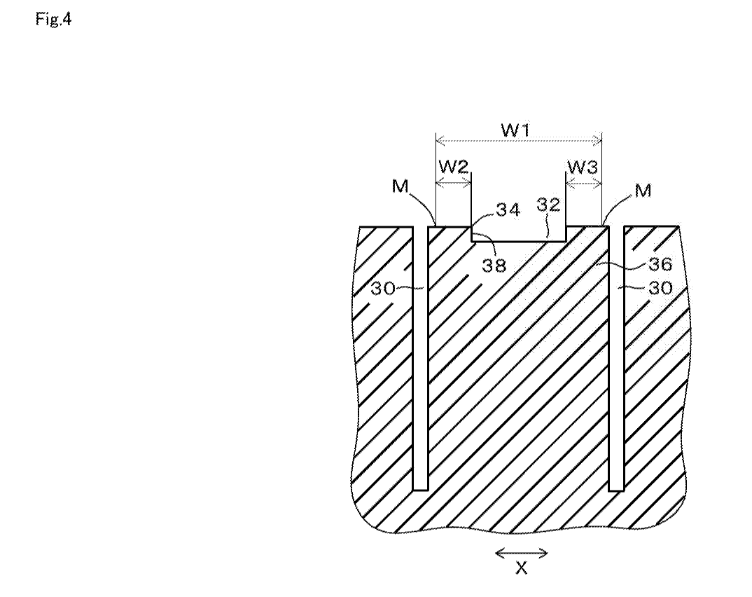

As illustrated in FIG. 2 to FIG. 4, recesses 32 are provided between the two adjacent sipes 30 in the center block 20. The sipes 30 and the recesses 32 do not contact each other and are separately provided from each other. Each of the recesses 32 in this embodiment has a circular shape when seen in the perpendicular direction to the ground contact surface (that is, an opening end 34 thereof to the ground contact surface has a circular shape). However, in each of the recesses, the shape of the opening end to the ground contact surface is not limited thereto but may have a polygonal shape such as a rectangular shape, a pentagonal shape, or a hexagonal shape, for example. Each of the recesses 32 preferably extends in the perpendicular direction to the ground contact surface while maintaining the shape of the opening end 34. However, at the opening end 34, each of the recesses 32 may expand in comparison with a portion below the opening end 34 (the inside of the recess 32). In addition, a side wall 38 (see FIG. 4) of each of the recesses 32 is preferably perpendicular to the ground contact surface but may slightly be tilted to the perpendicular direction to the ground contact surface. Each of the recesses 32 has depth that is equal to or greater than 0.05 mm and equal to or less than 0.5 mm.

Note that, in FIG. 2 to FIG. 3, the recesses 32 are also provided in a portion of the center block 20 between an end thereof in the tire circumferential direction X and the sipe.

In this embodiment, in the case where a distance between the sipes on both sides of the recess 32 is set as W1, a distance between the recess 32 and one of the sipes is set as W2, and a distance between the recess 32 and the other sipe is set as W3, each of W2/W1 and W3/W1 is equal to or greater than 0.1 and equal to or less than 0.3.

Here, as illustrated in FIG. 2, in the case where each of the sipes has the waved shape and apexes of the waved shape amplitude near the recess 32 are connected to define a virtual linear line M, the distance W1 between the sipes on both of the sides of the recess 32 corresponds to length of a linear line L1 that passes a center of the recess 32 and connects the virtual linear lines M on both of the sides of the recess 32 by the shortest distance. In addition, as illustrated in FIG. 3(a), in the case where each of the sipes has the linear shape or the single-curve shape, the distance W1 between the sipes on both of the sides of the recess 32 corresponds to length of a linear line L2 that passes the center of the recess 32 and connects the sipes on both of the sides of the recess 32 by the shortest distance.

As illustrated in FIG. 2, in the case where each of the sipes has the waved shape, the distance W2 between the recess 32 and the one sipe corresponds to a distance between the recess 32 and the virtual linear line M on the one sipe on the above linear line L1. In addition, as illustrated in FIG. 3(a), in the case where each of the sipes has the linear shape or the single-curve shape, the distance W2 between the recess 32 and the one sipe corresponds to a distance between the recess 32 and the one sipe on the above linear line L2.

As illustrated in FIG. 2, in the case where each of the sipes has the waved shape, the distance W3 between the recess 32 and the other sipe corresponds to a distance between the recess 32 and the virtual linear line M on the other sipe on the above linear line L1. In addition, as illustrated in FIG. 3(a), in the case where each of the sipes has the linear shape or the single-curve shape, the distance W3 between the recess 32 and the other sipe corresponds to a distance between the recess 32 and the other sipe on the above linear line L2.

Size of the opening end 34 of each of the recesses 32 and an arrangement position of each of the recesses 32 between the two sipes 30 are set such that each of W2/W1 and W3/W1 becomes equal to or greater than 0.1 and equal to or less than 0.3 as described above.

In this embodiment, a portion held between the two adjacent sipes 30 is set as a land section piece 36. In the case where at least one of the ends of the sipe is closed in the center block 20 like the sipe 30d illustrated in FIG. 3(d), an extension line N that extends from a closed position thereof to the end of the center block 20 in the same direction as an extending direction of the sipe 30d is defined, and a virtual line P that includes the sipe 30d and the extension line N is defined. Then, a portion held between the two adjacent virtual lines P is set as the land section piece 36.

The number of the recess 32 provided in the single land section piece 36 is not limited. However, it is preferred that a ratio of a total opening area of all of the recesses 32 provided in the single land section piece 36 to a ground contact area of the land section piece 36 is equal to or greater than 10% and equal to or less than 40%. Note that the opening area of the recess(es) 32 is not included in the ground contact area of the land section piece 36. The ground contact area is a ground contact area at the time when the pneumatic tire, which is attached to the legitimate rim and is filled with the air to have the legitimate inner pressure, contacts a flat ground surface and the legitimate load is exerted thereon.

The description has been made so far by using the center block 20 as the example. However, the block having above-described features of the sipe and the recess is not limited to the center block 20. At least one of the center block 20, the shoulder block 22, and the mediate block 24 may have the above-described features of the sipe and the recess.

That is, only one of the center block 20, the shoulder block 22, and the mediate block 24 may have the above-described features of the sipe and the recess, or all of the center block 20, the shoulder block 22, and the mediate block 24 may have the above-described features of the sipe and the recess.

In addition, two of the center block 20, the shoulder block 22, and the mediate block 24 may have the above-described features of the sipe and the recess. That is, the case where only the center block 20 and the shoulder block 22 have the above-described features, the case where only the center block 20 and the mediate block 24 have the above-described features, or the case where only the shoulder block 22 and the mediate block 24 have the above-described features is possible.

The pneumatic tire in this embodiment can be manufactured by a similar method to that of the general radial tire. However, a projection for the formation of the above recess 32 during vulcanization has to be provided on an inner surface of a vulcanizing mold. This projection may be a portion of a spring vent that is projected to the inside of the mold, the spring vent being used to release the air inside the mold to the outside.

Next, effects of this embodiment will be described.

Because the edge effect is exerted by each of the sipe and the recess 32, the pneumatic tire in this embodiment provides the superior travel performance on the frozen road surface.

Furthermore, because each of W2/W1 and W3/W1 is equal to or greater than 0.1 and equal to or less than 0.3 as described above, the edge effect by the sipe and the recess 32 is improved. Thus, the pneumatic tire in this embodiment provides the further improved travel performance on the frozen road surface. More specifically, because each of W2/W1 and W3/W1 is equal to or greater than 0.1, the rubber portion between the sipe and the recess 32 has sufficient thickness, and the portion can exert a large elastic force. Thus, the edge effect is improved, and the travel performance on the frozen road surface is further improved. In addition, because each of W2/W1 and W3/W1 is equal to or less than 0.3, the rubber portion between the sipe and the recess 32 is not excessively thickened and is deformable, and the portion can exert the large elastic force. Thus, the edge effect is improved, and the travel performance on the frozen road surface is further improved.

In addition, in the pneumatic tire of this embodiment, in the case where the ratio of the total opening area of all of the recesses 32 provided in the single land section piece 36 to the ground contact area of the land section piece 36 is equal to or greater than 10% and equal to or less than 40%, the edge effect by the recess 32 is further improved. Thus, the travel performance on the frozen road surface is further improved. More specifically, because the above ratio is equal to or greater than 10%, the rubber portion between the sipe and the recess 32 has the thickness that allows the deformation, and a circumference of the opening end 34 is increased due to enlargement of the opening end 34 of the recess 32. Thus, the edge effect by the recess 32 is further improved, and the travel performance on the frozen road surface is further improved. In addition, because the above ratio is equal to or less than 40%, rigidity of the land section piece 36 is secured. Thus, the edge effect by the recess 32 is further improved, and the travel performance on the frozen road surface is further improved.

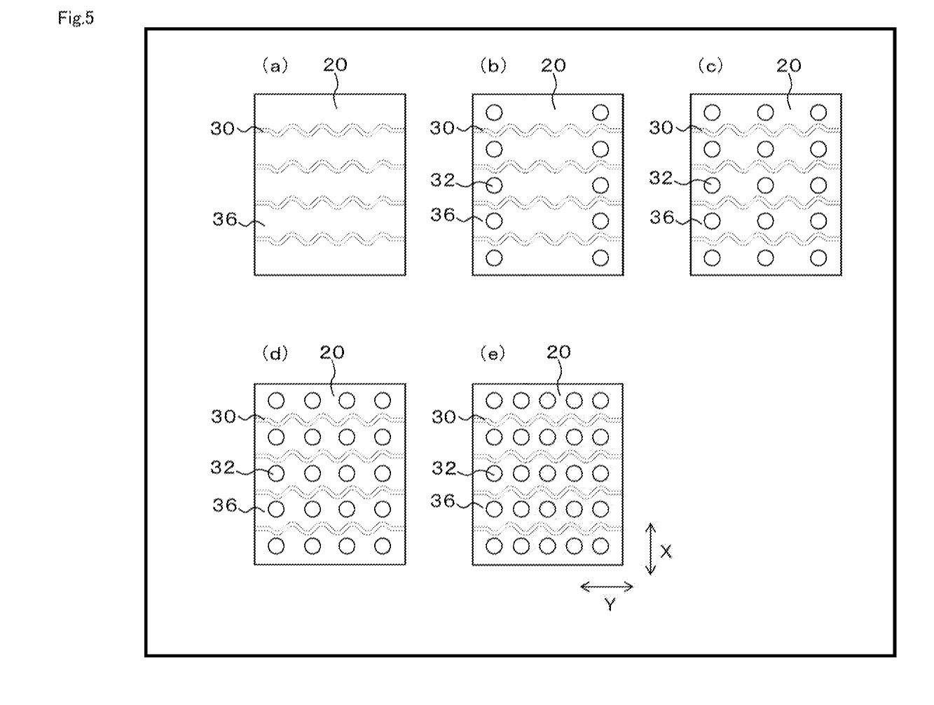

In order to confirm the effects of the embodiment that have been described so far, steering stability performance of pneumatic tires on an frozen road surface in a comparative example and examples illustrated in Table 1 and FIG. 5 was evaluated. A pneumatic tire in Comparative Example 1 illustrated in FIG. 5(a) differs from the pneumatic tire in the above embodiment in a point that the recess 32 is provided in none of the blocks. Pneumatic tires in Examples 1 to 4 illustrated in FIGS. 5(b) to (e) each have the same features as the pneumatic tire in the above embodiment and each include the recesses 32 in all of the blocks including the center blocks 20. The pneumatic tires in Examples 1 to 4 differ from each other in terms of the ratio of the total opening area of all of the recesses 32 provided in the land section piece 36 to the ground contact area of the land section piece 36.

In Comparative Example 1 and Examples 1 to 4, the ground contact area of the land section piece 36 was set to 84.4 mm. In addition, the opening area of the single recess 32 in Examples 1 to 4 was set to 3.14 mm², and the number of this recess 32 in the single land section piece 36 was set to two in Example 1, three in Example 2, four in Example 3, and five in Example 5.

The steering stability performance on the frozen road surface was evaluated as follows. First, a driver got on a vehicle, to which the pneumatic tires in each example are attached, and drove the vehicle for acceleration, braking, turning, and a lane change on the frozen road surface. Then, the driver made sensory evaluation of the steering stability performance. The evaluation was made by using an index for which a result of Comparative Example 1 was set to 100 and which indicated that the steering stability performance was superior as the index was increased.

The evaluation result is as illustrated in Table 1. It was confirmed that the pneumatic tires in Examples 1 to 4, each of which had the same features as those in the above embodiment, each had the superior steering stability performance on the frozen road surface to the pneumatic tire in Comparative Example 1. It was also confirmed that the ratio of the total opening area of all of the recesses 32 provided in the land section piece 36 to the ground contact area of the land section piece 36 had an impact on the steering stability performance on the frozen road surface.

TABLE 1

| | Compar- | | | | |
|---|---|---|---|---|---|
| | ative Exam- | Exam- | Exam- | Exam- | Exam- |
| | ple 1 | ple 1 | ple 2 | ple 3 | ple 4 |
| Drawing | FIG. | FIG. | FIG. | FIG. | FIG. |
| | 5(a) | 5(b) | 5(c) | 5(d) | 5(e) |
| Presence/absence | Absent | Present | Present | Present | Present |
| of recess | | | | | |
| Ratio of opening | — | 7.4% | 11.2% | 14.9% | 18.6% |
| area of all | | | | | |
| recesses provided | | | | | |
| in land section | | | | | |
| piece to ground | | | | | |
| contact area of | | | | | |
| land section piece | | | | | |
| Steering stability | 100 | 101 | 102 | 103 | 104 |
| performance on | | | | | |
| frozen road | | | | | |
| surface | | | | | |

The embodiment that has been described so far is merely illustrative, and the scope of the invention is not limited thereto. Various types of elimination, replacement, and modifications can be made to the embodiment that has been described so far within the scope that does not depart from the gist of the invention. The embodiment that has been described so far and the modifications thereof are included in the invention described in the claims and equivalence thereof.

1. A pneumatic tire having a tread provided with plural land sections, each of the land sections being provided with plural sipes and at least one recess arranged between the two adjacent sipes, wherein
in the case where a distance between the sipes on both sides of the recess is set as W1, a distance between the recess and one of the sipes is set as W2, and a distance between the recess and the other sipe is set as W3, each of W2/W1 and W3/W1 is equal to or greater than 0.1 and equal to or less than 0.3.

2. The pneumatic tire according to claim 1, wherein
the recess has depth that is equal to or greater than 0.05 mm and equal to or less than 0.5 mm.

3. The pneumatic tire according to claim 1, wherein
a ratio of a total opening area of all of the recesses provided in a land section piece that is a portion held between the two adjacent sipes to a ground contact area of the land section piece is equal to or greater than 10% and equal to or less than 40%.

4. The pneumatic tire according to claim 1, wherein
the recess has a circular shape when seen in a perpendicular direction to a ground contact surface.

5. The pneumatic tire according to claim 1, wherein
each of the sipes has a waved shape when seen in the perpendicular direction to the ground contact surface.

6. The pneumatic tire according to claim 1, wherein
each of the sipes extends in a tire width direction.

7. The pneumatic tire according to claim 1, wherein
each of the land sections is a block that is formed by a main groove extending in a tire circumferential direction and a lateral groove extending in the tire width direction.

8. The pneumatic tire according to claim 7, wherein
all of the land sections included in the pneumatic tire are the blocks, and
each of the blocks is provided with the sipe and the recess.
